(19) United States
(12) Patent Application Publication
(10) Pub. No.: US 2007/0090637 A1
(43) Pub. Date: Apr. 26, 2007

(54) Armrest for a baby stroller

(75) Inventor: Cheng-Fan Yang, Tainan Hsien (CN)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/585,852

(22) Filed: Oct. 25, 2006

(30) Foreign Application Priority Data
Oct. 25, 2005 (TW) 094218442

(51) Int. Cl. B60R 19/54

(52) U.S. Cl. 280/762

(57) ABSTRACT

An armrest for a baby stroller has a handle portion. The handle portion may be a protruded flange, an indented portion, a fixed handle grip or a flipable handle grip. By grabbing such a handle portion, a user can safely and conveniently lift and move the stroller.

### BACKGROUND OF THE INVENTION

1. Field of the Invention

This invention relates to a armrest for a stroller and, in particular, to an armrest which has a handle portion for convenient lifting and moving of the stroller by a user.

2. Description of the Prior Art

A conventional baby stroller normally has a pair of armrests which associate with a boundary frame to protect a baby from falling out of the stroller. The boundary frame may be combined with a food tray for the convenience of feeding a meal, in additional to the noted safety function.

When a user wants to move the baby and the stroller together, or wants to lift up the baby stroller while it is in an erect position, the user will normally grab the armrests of the stroller while moving the same. However, an armrest of a conventional stroller is made of plastic by a molding process. The bottom of the armrest is therefore not a smooth, flattened surface as is found on the top and the side walls, but instead may have fragile and sharp edges which may easily hurt the user's hand or fingers.

### SUMMARY OF THE INVENTION

In order to resolve the above-mentioned problems, the present invention provides an armrest with a handle portion. The handle portion may be a protruded flange, an indented portion, a fixed handle grip or a flipable handle grip. By grabbing such a handle portion, a user can safely and conveniently lift and move the stroller.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a perspective view schematically showing an armrest embodied on a frame of a baby stroller, according to the present invention;

FIG. 2 is a side view of the embodiment of FIG. 1;

FIGS. 3-1 to 3-6 are alternative embodiments of the armrest according to the present invention; and

FIG. 4 is a side view schematically showing the embodiment of FIG. 1 in a collapsed position.

### DETAILED DESCRIPTION OF THE PREFERRED EMBODIMENTS

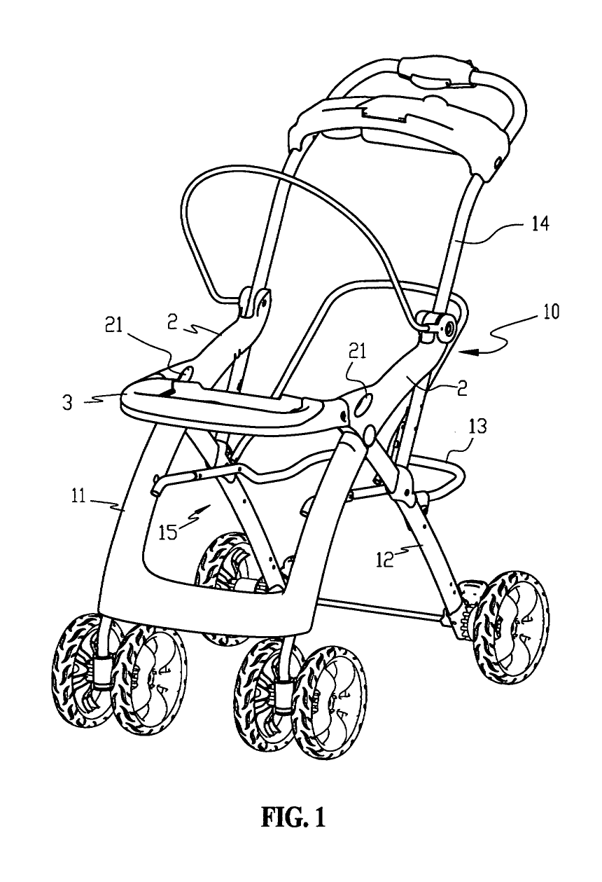

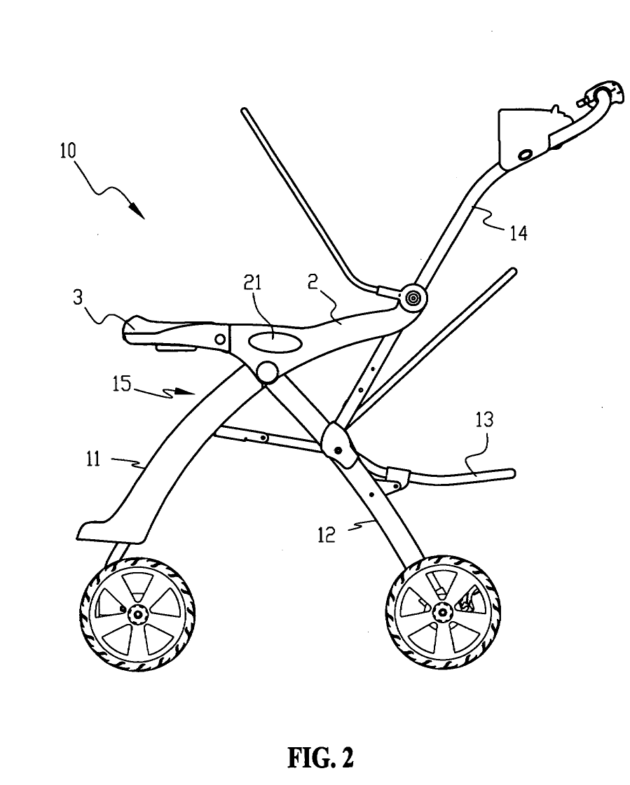

Referring to FIGS. 1 and 2, an embodiment of a pair of armrests on a baby stroller frame (10), according to the present invention. The baby stroller frame (10) has a collapsible linkage system (15) which can be deployed into an erect configuration and folded into a collapsed configuration. The stroller frame includes at least a pair of front legs (11), a pair of rear legs (12), a seat support (13), a pair of push arms (14), and a pair of armrests (2). The armrests (2) have one end connected with a boundary frame (3) and another end pivotally connected to a part of the push arms (14) and a handle portion (21), so as to allow a user to conveniently grab and move the baby stroller.

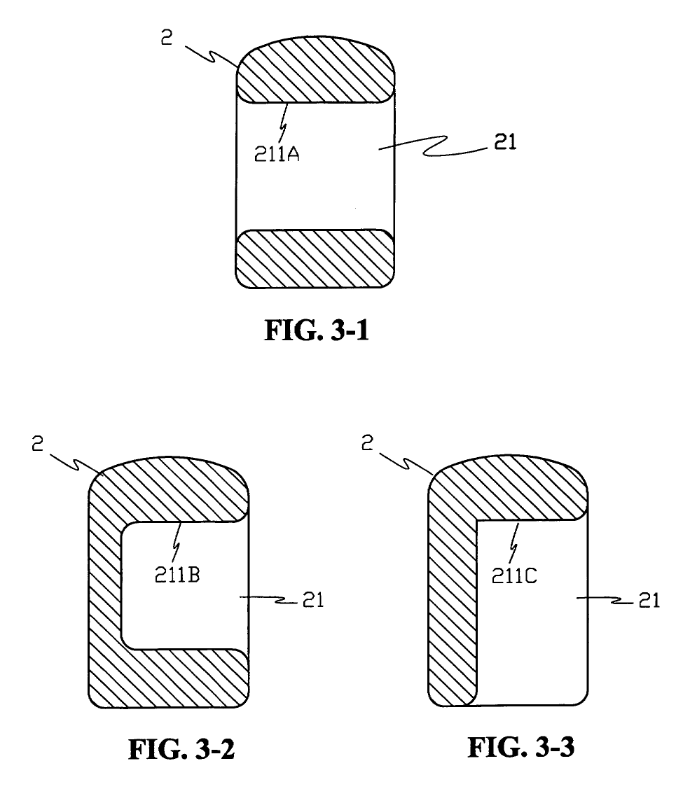

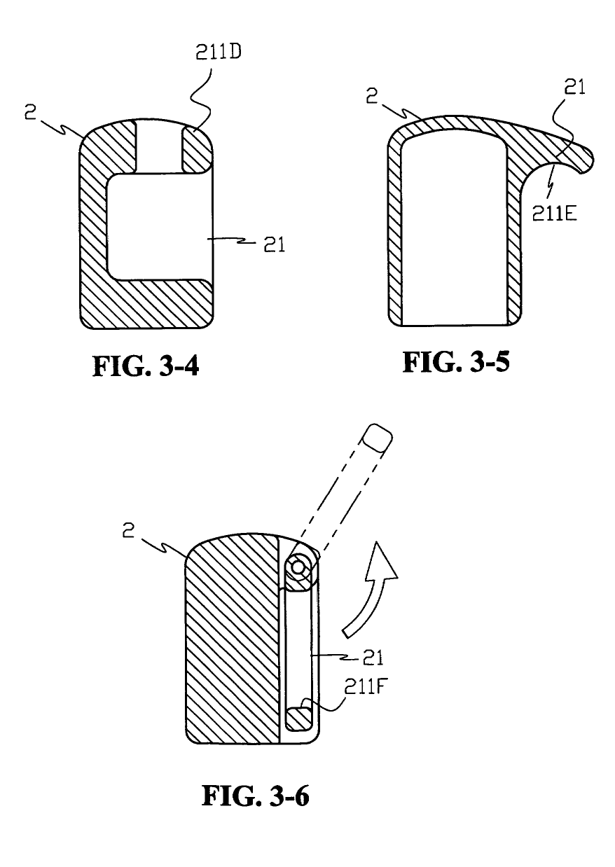

Referring to FIG. 3-1, the handle portion (21) may be a transverse through hole (211 A) through which a user's finger may pass, so as to grab the armrest (2) to move the baby stroller.

Referring to FIG. 3-2, the handle portion (21) may be a transverse indent (211B) into which a user's finger may rest, so as to grab the armrest (2) to move the baby stroller.

Referring to FIG. 3-3, the handle portion (21) may be an L-shaped indent (211C) into which a user's finger may rest, so as to grab the armrest (2) to move the baby stroller.

Referring to FIG. 34, the handle portion (21) may be an indent with a fixed hand grip (211D) for a user to grab and move the baby stroller.

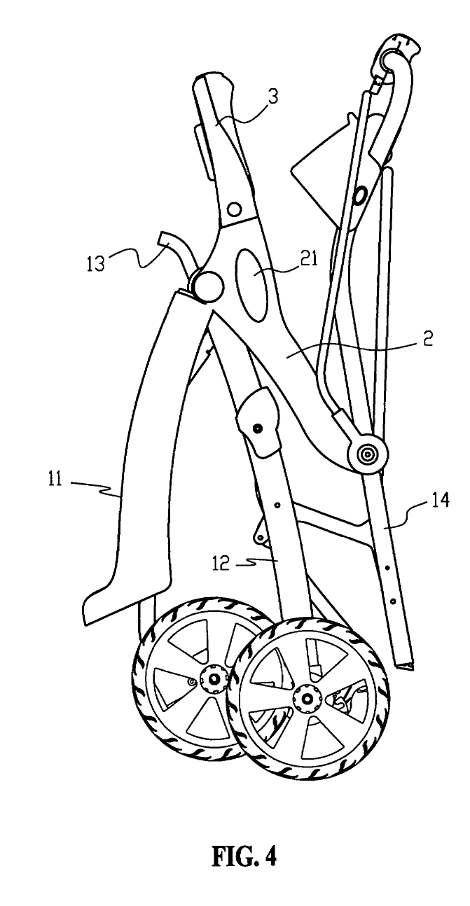

Referring to FIG. 3-5, the handle portion (21) may be an indent with a curved flange (211E) for a user to grab and move the baby stroller.

Referring to FIG. 3-6, the handle portion (21) may be an indent with a flipable hand grip (211F) for a user to grab and move the baby stroller.

Referring to FIG. 4, a baby stroller with an armrest (21) according to the present invention may be collapsed into a folded position. Further referring to FIGS. 1 and 4, the handle portion (21) of the armrest (2) is preferably arranged near the center of gravity of the baby stroller, so as to allow a user to lift and move the baby stroller stably and safely.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An armrest for a baby stroller, the baby stroller having a frame with a pair of push arms, and the armrest comprising:
one end pivotally connected to a part of one of the push arms; and
a handle portion formed with a through hole for a user to grab by hand.

2. The armrest as claimed in claim 1, further comprising another end connected with a boundary frame.

3. The armrest as claimed in claim 2, wherein the boundary frame is connected with a food tray.

4. The armrest as claimed in claim 2, wherein the boundary frame is a food tray.

5. An armrest for a baby stroller, the baby stroller having a frame with a pair of push arms, and the armrest comprising:
one end pivotally connected to a part of one of the push arms; and
a handle portion having an indent for a user to grab by hand.

6. The armrest as claimed in claim 5, further having another end connected with a boundary frame.

7. The armrest as claimed in claim 6, wherein the boundary frame is connected with a food tray.

8. The armrest as claimed in claim 6, wherein the boundary frame is a food tray.

9. The armrest as claimed in claim 6, wherein the indent is U-shaped.

10. The armrest as claimed in claim 6, wherein the indent is L-shaped.

11. The armrest as claimed in claim 6, wherein the indent is L-shaped and forms a curved flange.

12. The armrest as claimed in claim 6, wherein the indent is L-shaped and is formed with a fixed handle grip.

13. An armrest for a baby stroller, the baby stroller having a frame with a pair of push arms, and the armrest comprising:
one end pivotally connected to a part of one of the push arms; and
a handle portion connected with a flipable handle grip.

14. The armrest as claimed in claim 13, further having another end connected with a boundary frame.

15. The armrest as claimed in claim 14, wherein the boundary frame is connected with a food tray.

16. The armrest as claimed in claim 14, wherein the boundary frame is a food tray.
